(19) United States
(12) Patent Application Publication
(10) Pub. No.: US 2002/0086599 A1
(43) Pub. Date: Jul. 4, 2002

(54) Method for enhancing insulation materials

(76) Inventors: William Francis McNally, Clarks Summit, PA (US); Joel M. Furey, Wolcott, VT (US)

Correspondence Address: Richard A. Paikoff, Duane, Morris & Heckscher LLP, One Liberty Place, Philadelphia, PA, 19103-7396, US

(21) Appl. No.: 09/754,815

(22) Filed: Jan. 4, 2001

(51) Int. Cl. B32B 9/00

(52) U.S. Cl. 442/117; 442/153; 442/180; 442/378; 428/615; 428/361; 428/379; 428/389

(57) ABSTRACT

A method for enhancing insulation materials without increasing the weight, thickness or density of the materials is disclosed, which includes adding to the materials an amount, effective for the purpose, of a metal-coated staple fiber, filament fiber or fabric.

### BACKGROUND OF THE INVENTION

The use of silver for its medical and therapeutic benefits is well known. Today, silver is used for its broad-spectrum antimicrobial properties and healthcare products including, e.g., bandages, burn care treatments and catheters. In addition, many individuals are first exposed to silver at birth, when silver nitrate eye drops are used to prevent infection. Silver is also widely used for industrial applications, most notably in drinking water filters and swimming pool filtration systems.

The present invention utilizes metal-coated fibers or fabrics to enhance traditional synthetic or natural insulation materials (including fiberglass, fiberfill, ceramic, cellulose, etc.) by significantly increasing insulation values without increasing weight, thickness or density of the materials.

### SUMMARY OF THE INVENTION

The present invention relates to a method for enhancing insulation materials without increasing the weight, thickness or density of the materials, which comprises adding to the materials an amount, effective for the purpose, of a metal-coated staple fiber or filament fiber (metal-coated fiber) or fabric (metal-coated fabric), collectively, a metal-coated material. In a further embodiment of the present invention, the metal-coated fabric is added to a fiber that is already attached to the insulation materials.

### DESCRIPTION OF THE PREFERRED EMBODIMENTS

The present invention serves to enhance traditional insulation materials by significantly increasing their insulation properties, without a corresponding increase in weight, thickness or density of the materials. In the construction of the metal-coated fiber, such materials may be included as a single layer or multiple layers on the surface of and/or in the middle of traditional non-woven, woven, knit or extruded insulation materials. The metal-coated fiber thus becomes an integral component of the insulation material. Furthermore, the metal-coated fabric may be included as a single layer or as multiple layers on the surface and/or in the middle of knit and woven fabrics designed for thermal insulative purposes.

In the construction of the present invention, metal-coated fibers are knit, woven or non-woven into a fabric with other yarns (e.g., polyester, polypropylene, nylon, cotton, acrylics, etc.), with the resulting fabric being included as a single layer or multiple layers on the surface of and/or in the middle of traditional non-woven or extruded insulation materials. The metal-coated material may also be knit or woven directly into a fabric construction. The metal-coated material may also be included in construction or “house wrap” material (e.g., Tyvek®, available from DuPont), which is layered in a construction either inside or outside traditional insulation materials.

In practice, insulation is added to a given product in order to separate the environments on either side of the insulation, and maintain their respective temperatures. In order to maximize a particular benefit of an insulating material, it is desirable to reflect as much external energy as possible prior to air entering the insulation. Note that many insulation materials currently use aluminum to reflect radiative energy. While aluminum is reflective, it is not nearly as reflective as e.g., silver or gold. Aluminum also adds significant weight to the insulation, as it often takes the form of a foil. metals with very high reflectivity values, such as gold and silver, would be ideal candidates for this purpose, but in solid form are extremely expensive and would add significant weight to the resulting materials. Thus, metal-coated fibers impart all of the attributes of a pure metal substance, while significantly reducing the actual metal content. As a result, the fiber will maintain the reflectivity performance of the pure metal without increasing the weight of said materials, and does so in a cost-effective manner. Surprisingly, by incorporating a metal-coated fiber into the actual insulating material or into a fabric that has been attached to the insulating material, it is possible to significantly increase the thermal performance of the insulation, without a corresponding increase in weight, thickness or density in the materials. Further benefits of the present invention include the properties of reflecting electromagnetic radiation and reducing electrostatic charges of the resulting materials. The antimicrobial benefits of silver will also enhance the insulation material. The metal-coated material will eliminate the growth of bacteria and fungi, thereby extending the life of the insulation material (bacteria and fungi lead to the breakdown of insulation materials).

Silver, the preferred metal for purposes of the present invention, has an infrared (IR) reflectivity rating of up to 95%, the highest of any element. In other words, 95% of the radiative energy that contacts silver will be reflected back to its source. As a result, the metal coated staple fiber or fabric of the present invention minimizes radiative heat loss by actively reflecting radiative energy back to its source. For instance, apparel designed for cold weather use that incorporates the metal-coated material of the present invention will be significantly warmer than apparel without the enhanced material.

Silver also has one of the lowest emissivity ratings of any element, which means that it radiates thermal energy very slowly. Silver will retain heat for a very long period of time (as opposed to many other elements, which would retain heat for a very short period of time). For example, with the incorporation of the present invention into prevailing apparel materials, any heat not reflected back to the body by the fiber will be absorbed and stored in the fiber for an extended period of time. As a result, the preferred metal-coated material product will keep the wearer warmer for a longer period of time than a passive fiber system. Conversely, in warm weather, when conduction is the primary means of heat transfer, the present invention will enhance the body's natural actions by accelerating the conduction of heat from the skin (i.e., a fabric without the metal coated staple fiber/fabric treatment would simply be a barrier to heat conduction). Thus, treated materials will conduct heat from the skin to the ambient air, thereby cooling the body. While silver is the preferred metal to be used in accordance with the present invention, other metals may be used as well, e.g., gold, nickel, copper, aluminum or any other metal with reflective properties.

In a further preferred embodiment of the present invention, a fine web of metal-coated filaments is created using a staple fiber, with it incorporated through a needle punch or other non-woven textile methodology into an insulation-like material, in order to enhance the insulative qualities of the material, as well as to enhance the performance of the prevailing metal-coated staple fiber/fabric.

While this invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

We claim:

1. A method for enhancing insulation materials without increasing the weight, thickness or density of said materials, which comprises adding to said materials an amount, effective for the purpose, of a metal-coated material.

2. The method as recited in claim 1 wherein said insulation materials are fiberglass.

3. The method as recited in claim 1 wherein said insulation materials are selected from the group consisting of fiberfill, ceramic and cellulosic materials.

4. The method as recited in claim 1 wherein said metal-coated material is included as a single layer or multiple layers.

5. The method as recited in claim 4 wherein said metal-coated material is applied on the surface or in the middle of said insulation materials.

6. The method as recited in claim 5 wherein said insulation materials are non-woven or extruded insulation materials.

7. The method as recited in claim 1, wherein said metal-coated material comprises silver.

8. The method as recited in claim 1, wherein said metal-coated material includes gold, nickel, copper, or aluminum.

9. The method as recited in claim 1, wherein said metal-coated material is knit or woven with other yarns.

10. The method as recited in claim 9, wherein said yarns are selected from the group consisting of polyester, polypropylene, nylon, cotton and acrylic materials.

11. A method for enhancing insulation materials without increasing the weight, thickness or density of said materials, which comprises adding to a fabric that is attached to the insulation materials an amount, effective for the purpose, of a metal-coated material.

12. The method as recited in claim 11 wherein said metal-coated material reflects electromagnetic radiation.

13. The method as recited in claim 11 wherein said metal-coated material reduces electrostatic charges.

14. The method as recited in claim 11 wherein said metal-coated material has antimicrobial properties.
